(19) United States
(12) Patent Application Publication
(10) Pub. No.: US 2016/0178131 A1
(43) Pub. Date: Jun. 23, 2016

(54) LIQUEFIED GAS TANK WITH BREAKING MEANS FOR INFLATION OF SEALED COMPARTMENTS AND BAG FOR SEALING CABLE DUCTS INCLUDED IN SAID TANK

(71) Applicant: Ignacio Garcia Perez, Benimodo (ES)

(72) Inventor: Ignacio Garcia Perez, Benimodo (ES)

(73) Assignee: MAKINGPARTS, S.L., Valencia (ES)

(21) Appl. No.: 14/403,948

(22) PCT Filed: May 25, 2012
(86) PCT No.: PCT/ES2012/070385

§ 371 Date: Jan. 12, 2016

(51) Int. Cl. F17C 13/06; F17C 5/06; F17C 1/14; F17C 13/04

(52) U.S. Cl. CPC F17C 13/06; F17C 13/04; F17C 5/06; F17C 1/14; F17C 2201/0138; F17C 2223/0153; F17C 2270/0772

(57) ABSTRACT

Liquefied gas tank that is easy to machine and quick to operate and bag for sealing cable ducts incorporating said tank. The tank is provided with breaking means for inflating sealed compartments composed of a main pipe (1) closed on one side, an outlet pipe (4) inserted on the other side of the main tube through a first end (6) and closed on the distal end thereof, wherein the outlet pipe is provided with a narrowing (5) that defines a breaking point and an internal orifice (8) that extends from the first end of the outlet pipe to the narrowing (5) towards the distal end, and wherein the size of the narrowing (5), the size of the orifice (8) and the length of the outlet pipe (4) are determined such that a force applied on a lever of between 19N and 80N will break the outlet pipe (4) at the breaking point (5), releasing the gas through the orifice (8).

### FIELD OF THE INVENTION

The present invention relates to pneumatic devices such as safety or rescue vests, sealed sheets or bags for sealing ducts, pipes, connection boxes, etc. Specifically, the invention relates to a tank containing a liquefied gas which, when the tank is opened, is released into the pneumatic device causing the expansion thereof.

### BACKGROUND OF THE INVENTION

Safety or rescue vests are known which incorporate therein a gas tank or compressed air bottles allowing the auto-inflation of the vests, in order to cushion impacts in case of falls, maintain floatability, etc. However, most of these include elements attached externally to the vest itself, such as cords, carabiners, rings or the like which can break or be damaged, with the resulting risk that when these elements must be used they may not be in operative condition to fulfil their purpose.

There are also several pneumatic devices for sealing pipes, electrical lines or telephone lines by the internal expansion of a gas or liquid. Depending on the location thereof, these devices can also be used to prevent said pipes or ducts from being blocked. Patent U.S. Pat. No. 5,131,433 describes a complex sealing device comprising a bag that can be expanded with a gas supplied by a gun with pressurised gas provided with a handle actuator mechanism. Patent U.S. Pat. No. 5,113,912 describes a simpler mechanism composed of an inflatable ring provided with a valve, which however requires an external gas source. None of these devices can be inflated with the speed required in certain applications.

Another problem with existing tanks is that the volume of air or gas that can be introduced therein is very limited, as the pressure needed to fill the tank can be as high as 400 bar, such that these tanks are highly hazardous. The obvious solution is to increase the volume of the tank, which is not convenient in certain applications.

### OBJECT OF THE INVENTION

The object of the invention is to overcome the technical problems discussed in the preceding section. For this purpose, a liquefied gas tank is provided having breaking means for the inflation of sealed compartments and consisting of a main steel pipe closed on one side, an aluminium outlet pipe inserted on the other side of the main tube on a first end and closed on the distal end, wherein the outlet pipe is provided with a narrowing that defines a breaking point and an internal orifice that extends from the first end of the outlet pipe and beyond the narrowing towards the distal end, and wherein the size of the narrowing, the size of the orifice and the length of the outlet pipe are determined such that a force between 19 N and 80 N will break the outlet pipe at the breaking point, releasing the gas through said orifice. Preferably, the filler gas is CO₂. The cross section of the main pipe can be variable. To assist filling the tank, a valve may be provided therein. The closed side of the main pipe preferably comprises a plug or ball. The outlet pipe can comprise a stop at its first end and an element for regulating the flow of liquefied gas inserted at least partially in the orifice. Since the gas is liquefied, it is possible to increase considerably the volume thereof with respect to the volume of the existing tanks, without compromising safety. Due to the breaking means, the actuation is considerably quicker than in the devices of the prior art. The invention also relate to a bag for sealing ducts for cables that comprises therein a tank according to the invention described above.

### BRIEF DESCRIPTION OF THE FIGURES

To aid a better understanding of the features of the invention according to a preferred embodiment thereof, the following description of a set of drawings is accompanied where, for purposes of illustration, the following is shown:

FIG. 1 is a schematic representation of the invention according to a first embodiment.

FIG. 2 is a cross sectional view of FIG. 1.

FIG. 3 is a cross-sectional view of another embodiment.

FIG. 4 shows the two basic components of the invention in an assembled position.

FIG. 5 shows a variation of the perimeter of the outlet pipe.

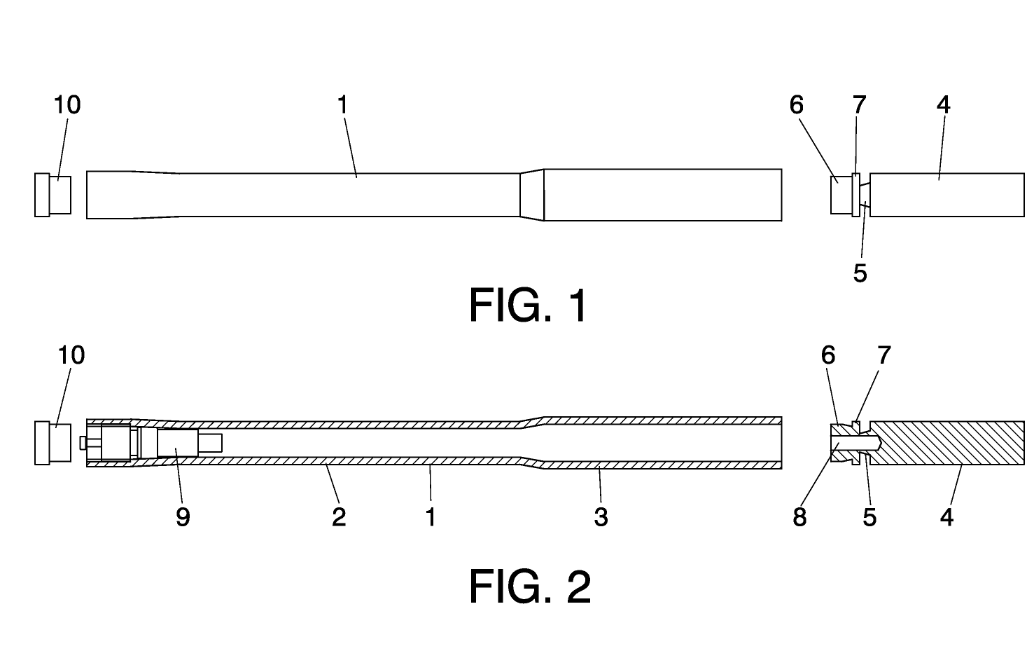

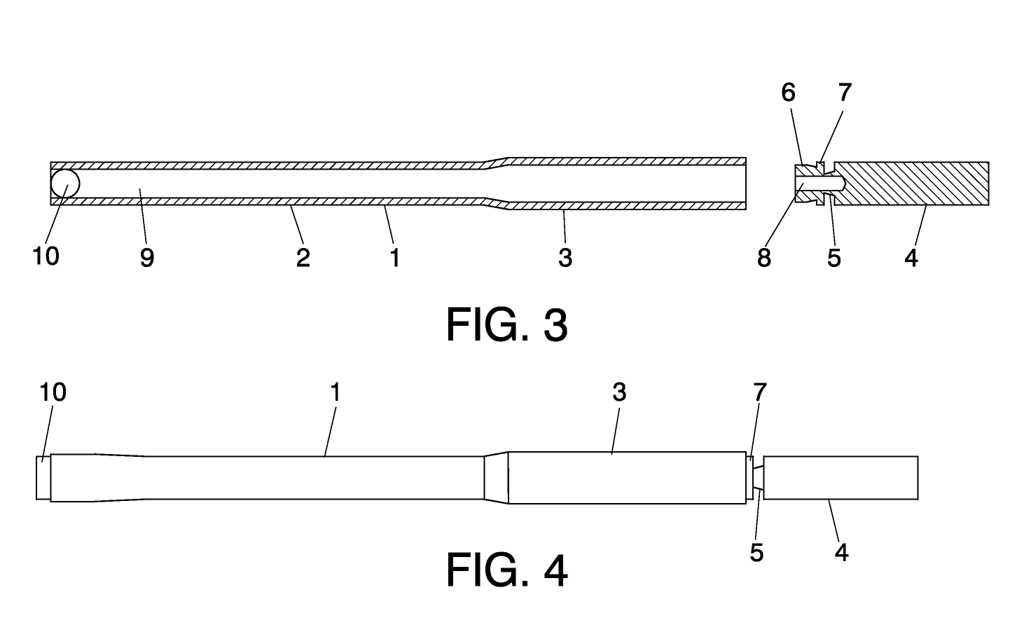

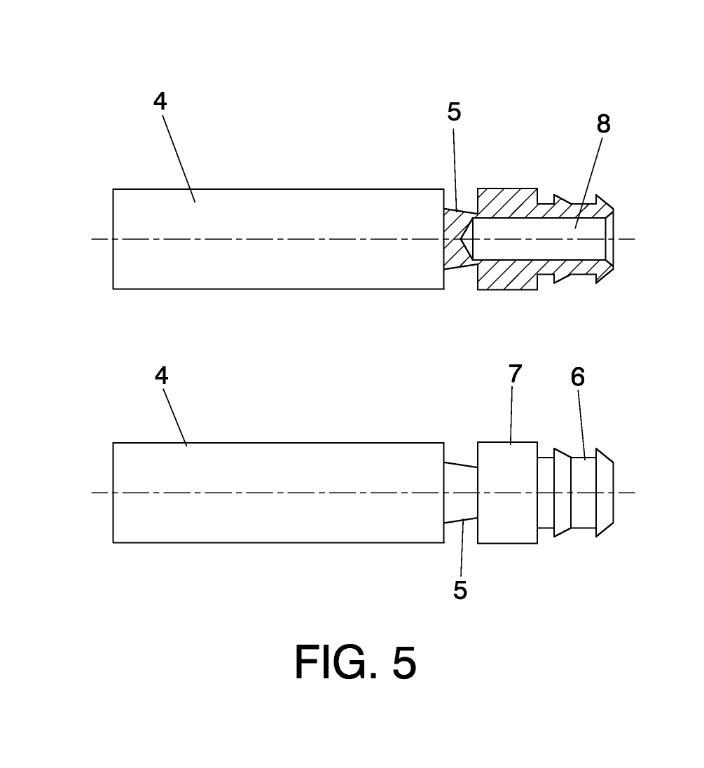

### DETAILED DESCRIPTION OF THE INVENTION

The two essential components of the invention are a main tubular element (1) and the part intended for the liquefied outlet mouth or outlet pipe (4). Both of these parts are tubular, preferably (but not necessarily) circular in cross section. The figures show how in one embodiment both parts are in a same plane. In another embodiment (not shown in the figures), one of the two parts can be curved to facilitate the breaking of the tank. The main element (1) is meant to contain a liquefied gas, such as a cooling gas, N₂ or preferably CO₂. The diameter of the pipe can change along the length thereof, defining different cross sections (2, 3). The cross sections can thus be adjusted to the volume of liquefied gas contained and the dimensions of the device that will expand. The pipe meant to house the outlet mouth (4) for the liquefied gas is closed on one end, while the other end (6) thereof has a diameter slightly smaller than that of the main element, such that the former can fit in the latter. Said end (6) can have a stop (7) and an inner orifice (8). The outlet pipe (4) has a narrowing or groove at the location of the breaking circumference or point (5).

When inserted in the main pipe, the stop prevents the narrowing from being inside the main pipe. The inner orifice (8) extends towards the closed end and can protrude slightly from the narrowing. Accordingly, when the gas is needed to expand the device to which the tank is related, it is only necessary to apply a torque on the outlet pipe (4) such that the pipe breaks at its narrowest part (5); the end of the pipe (6) will thus be inside the main pipe (1) and the orifice (8) will be free, releasing the gas through the same. The tank is opened by one of the essential features of the invention in a quick and simple manner. A person skilled in the art will recognise multiple combinations of dimensions of the narrowing, orifice and length of the outlet pipe according to the materials used, such that applying a force between 19 and 80 N (a normal force applied by a person) will easily break the tank at the breaking point.

The tank can be filled with liquefied gas through a valve (FIG. 2, ref. 9) that can remain inside the tank once the latter has been sealed with a plug (10) of ball. Alternatively, the valve may not be necessary if the filling is performed using a tool external to the device allowing to inject the liquefied gas and also to insert the ball in the end of the tank, acting as a sealing plug to prevent an undesired escape of the liquefied gas at the corresponding end.

Preferably, the plug (10) and the end of the pipe (6) are inserted inside the main pipe (1) by riveting, welding or the like. Inside the orifice (8) of the outlet pipe (4) can be placed, optionally, an element to regulate the gas flow. This element can have the form of a small rod or stud, preferably screwed in the orifice (8), such that the liquefied gas is released more slowly and gradually, thereby preventing the risk of a sudden release of the gas. This element can also be formed as a pad, such as with an elliptical shape.

The main pipe is made of steel and can withstand the pressure of the filler liquefied gas, which is approximately 55 bar (steel can withstand up to 350 bar). The outlet pipe (4) is made of aluminium.

In a possible embodiment of the invention, the outlet pipe has a length of about 30 mm and a diameter slightly smaller than that of the main pipe, from 6 to 8 mm. This length and diameter provide an optimum supporting surface for breaking at the narrowing point (5), which is about 2 mm long and 2.75 mm wide. The thickness of material between the orifice and the narrowing is from 0.10 to 0.12 mm.

A particularly practical application of the tank of the invention is in bags for sealing telephone or electrical cable ducts. In this case the tank is attached inside a bag which, when vacuum-sealed, causes a depression inside said bag such that it houses and contains the tank without requiring additional attachment means.

During the manufacturing process of the tank the interior thereof can be impregnated with an industrial oil to prevent internal corrosion.

The tank of the invention is easy to machine and assemble as it is made with parts having simple shapes. It does not require structurally complex parts or additional elements such as cords, carabiners, rings, ring tabs or the like neither inside the sealed compartment that it is intended for nor outside the same. This prevents any damage or accidental breaking thereof that may prevent the operation of the device itself. In addition, it is very easy to assemble, streamlining the production process.

1. Liquefied gas tank with breaking means for the inflation of sealed compartments comprising a pressurised gas, characterised in that it consists of a main pipe (1) closed on one side, an outlet pipe (4) inserted on the other side of the main tube through a first end (6) and closed on the distal end thereof, wherein the outlet pipe is provided with a narrowing (5) that defines a breaking point and an internal orifice (8) that extends from the first end of the outlet pipe to the narrowing (5) towards the distal end, and wherein the size of the narrowing (5), the size of the orifice (8) and the length of the outlet pipe (4) are determined such that a force applied on a lever of between 19 N and 80 N will break the outlet pipe (4) at the breaking point (5), releasing the gas through the orifice (8).

2. Liquefied gas tank according to claim 1 wherein the main pipe (1) is made of steel and the outlet pipe (4) is made of aluminium.

3. Liquefied gas tank according to claim 1 or 2 wherein the filler gas is CO₂.

4. Liquefied gas tank according to any of the preceding claims wherein the cross section (2, 3) of the main pipe (1) is variable.

5. Liquefied gas tank according to any of the preceding claims wherein the main pipe (1) or the outlet pipe (4) is curved.

6. Liquefied gas tank according to any of the preceding claims also comprising a valve (9) at the main pipe (1) to facilitate filling with gas.

7. Liquefied gas tank according to any of the preceding claims wherein the closed side of the main pipe comprises a plug or ball (10).

8. Liquefied gas tank according to any of the preceding claims also comprising a stop (7) at the first end of the outlet pipe (6).

9. Liquefied gas tank according to any of the preceding claims also comprising an element for regulating the gas flow in the orifice (8).

10. Liquefied gas tank according to claim 9, characterised in that the gas flow regulating element is a rod or stud screwed in the orifice (8).

11. Liquefied gas tank according to any of the preceding claims incorporating industrial oil on the inside thereof.

12. Bag for sealing cable ducts comprising inside thereof a tank according to any of the preceding claims.
